(19) United States
(12) Patent Application Publication
(10) Pub. No.: US 2023/0002643 A1
(43) Pub. Date: Jan. 5, 2023

(54) ADHESIVE FILM AND METHOD FOR MANUFACTURING THEREOF

(71) Applicant: 3M INNOVATIVE PROPERTIES COMPANY, Saint Paul, MN (US)

(72) Inventor: Jihwan Jang, Seoul (KR)

(21) Appl. No.: 17/757,282

(22) PCT Filed: Dec. 15, 2020
(86) PCT No.: PCT/IB2020/061971

§ 371 Date: Jun. 13, 2022

Related U.S. Application Data
(60) Provisional application No. 62/949,902, filed on Dec. 18, 2019.

(51) Int. Cl. C09J 7/24; C09J 7/20

(52) U.S. Cl. CPC C09J 7/243; C09J 7/203; C09J 2301/122

(57) ABSTRACT

The present disclosure relates to an adhesive film. Specifically, according to an embodiment of the present disclosure, there may be provided an adhesive film including: a guide film including a first area and a second area surrounding the first area; and an adhesive layer disposed on the first area, wherein the first area has a shape corresponding to a shape of the adhesive layer, wherein a cut-out portion disposed on a position adjacent to the adhesive layer is provided within a circumference of the second area.

### FIELD

The present disclosure relates to an adhesive film and a method for manufacturing thereof.

### BACKGROUND

Designs of smartphones have been developed for years. Above all, the development of displays of smartphones has influenced changes in design as well as performance of smartphones. In particular, displays having flexibility enable curved displays and lead various changes in smartphone design. Accordingly, technologies for double edge bended displays have been developed, and many smartphone manufacturers have produced double edge bended smartphones.

With the development of performance and design of smartphones, the change in displays is accompanied by change in methods for making displays. A display panel is not simply a single product that is completed by laminating various core materials in the form of a film. For example, one display may be configured by laminating an organic light emitting diode (OLED), a polarizer, a touch sensor, and the like, and laminating a cover window on top. However, in order to complete the display, not only providing various materials in the form of a film is required, but also firmly bonding between the materials is required. An optical clear adhesive (OCA) is widely used as an adhesive to bond various materials constituting the display. In addition, a liner film may also be used to guide the OCA to be bonded to the cover window.

### SUMMARY

A quad edge bended display which has four edges bended in addition to both edges is suggested, and efforts to develop technology for the quad edge bended display have been made. However, there are various problems in developing the technology for the quad edge bended display.

An example of these problems is that the OCA may wrinkle due to a tension of the liner film when the OCA is bonded to the cover window, or air bubbles may be generated between the OCA and the cover window. The air bubbles may reduce adhesiveness between the cover window and the OCA, and may cause reflection or refraction of light between the OCA and the cover window, resulting in a blurred image on the display.

To solve the above-described problems, a method for manufacturing an OCA by using a polypropylene film having a higher elongation than a PET film which is widely used as a liner film has been suggested. In addition, recently, there is an increasing need for a polypropylene film which can prevent air bubbles from being generated between an OCA and cover glass by reducing a tension of a film with a high elongation, and also, can prevent wrinkles on the OCA, and provide increases a production rate.

Embodiments of the present disclosure are invented by considering the above, and providing an adhesive film which can minimize wrinkles generated on an adhesive layer when the adhesive layer is attached to a material, and can prevent air bubbles from being generated between the adhesive layer and the material.

According to one aspect of the present disclosure, there is provided an adhesive film including: a guide film comprising a first area and a second area surrounding the first area, and an adhesive layer disposed on the first area. The first area has a shape corresponding to a shape of the adhesive layer, and a cut-out portion is provided within a circumference of the second area and positioned adjacent to the adhesive layer.

In addition, the present disclosure provides the adhesive film, wherein the adhesive layer includes a corner portion, and the cut-out portion is disposed on a position adjacent to the corner portion.

According to embodiments of the present disclosure, there are effects that, when the adhesive layer is attached to a material, wrinkles on the adhesive layer are minimized, and air bubbles are not generated between the adhesive layer and the material.

In addition, there are effects that wrinkles on the adhesive layer are minimized, air bubbles are not generated between the adhesive layer and a material, and also, a production rate is increased.

The present disclosure also provides an adhesive film laminating method for laminating an adhesive film on a cover window, the adhesive film having a guide film and an adhesive layer disposed on one side of the guide film, the cover window having a planar portion and a plurality of bending edge portions positioned around the planar portion. The method comprises bringing the adhesive film and the cover window into contact with each other to bond the adhesive layer to the cover window, and removing the guide film from the adhesive layer.

In another aspect, the present disclosure provides an adhesive film fabrication method comprising providing a guide film, placing an adhesive layer on the guide film, and forming a cut-out portion to be disposed on a position adjacent to a corner portion of the adhesive layer.

### BRIEF DESCRIPTION OF THE DRAWINGS

FIG. 1 is a top view of an adhesive film according to an embodiment of the present disclosure;

FIG. 2 is an exploited perspective view of the adhesive film of FIG. 1;

FIG. 3 is a cross-sectional view of the adhesive film of FIG. 1, taken along the line X-X′;

FIG. 4 is a top view of a guide film of FIG. 1;

FIG. 5 is a top view of an adhesive film according to a second embodiment of the present disclosure;

FIG. 6 is a top view of an adhesive film according to a variation of the second embodiment of the present disclosure;

FIG. 7 is a front view of the adhesive film of FIG. 6;

FIG. 8 is a perspective view showing an adhesive film which is disposed on a stage before being laminated on a cover window according to an embodiment of the present disclosure;

FIG. 9 is a front view illustrating the stage of FIG. 8 which is moved up toward the cover window;

FIG. 10 is a sequence diagram schematically illustrating an adhesive film manufacturing method which laminates an adhesive film on a cover window according to embodiments of the present disclosure; and

FIG. 11 is a sequence diagram schematically illustrating a method for fabricating an adhesive film according to embodiments of the present disclosure.

### DETAILED DESCRIPTION

Hereinafter, specific embodiments for implementing the concept of the present disclosure will be described in detail with reference to the drawings.

Further, in explaining the present disclosure, any specific explanation on a well-known related configuration or function deemed to obscure the gist of the present disclosure will be omitted.

In addition, it should be understood that, when a certain element is referred to as being “connected to,” “bonded to,” “disposed on,” or “in contact with” another element, the certain element can be directly connected to, bonded to, disposed on, or in contact with another element, but there may be an intervening element therebetween.

The terms used herein are only for describing certain exemplary embodiments, and not intended to limit the scope of the disclosure. Unless otherwise specified, a singular expression includes a plural expression.

In addition, throughout the description, the expression “upper side” or the like is described with reference to illustrations in the drawings, and it is to be noted that this may be expressed differently when the orientation of a corresponding object is changed. For the same reason, some element may be exaggerated, omitted or schematically illustrated in the drawings, and the size of each element does not entirely reflect a real size.

In addition, the terms including ordinal numbers such as ‘first’ and ‘second’ may be used to describe various elements, but these elements should not be limited by such terms. These terms are used for the purpose of distinguishing one element from another element only.

The term “includes” used in this specification specifies a specific feature, area, integer, step, operation, element, and/or component, and does not preclude the presence or addition of other specific features, areas, integers, steps, operations, elements, components, and/or groups.

Hereinafter, a detailed configuration of an adhesive film 1 according to an embodiment of the present disclosure will be described with reference to the drawings.

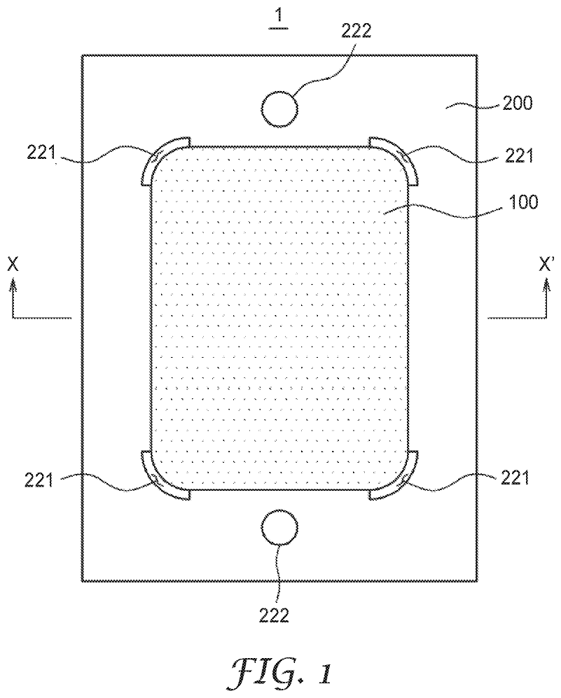

Referring to FIG. 1, the adhesive film 1 according to an embodiment of the present disclosure may be used to laminate materials included in a display panel and to bond therebetween. The adhesive film 1 may include an adhesive layer 100 and a guide film 200.

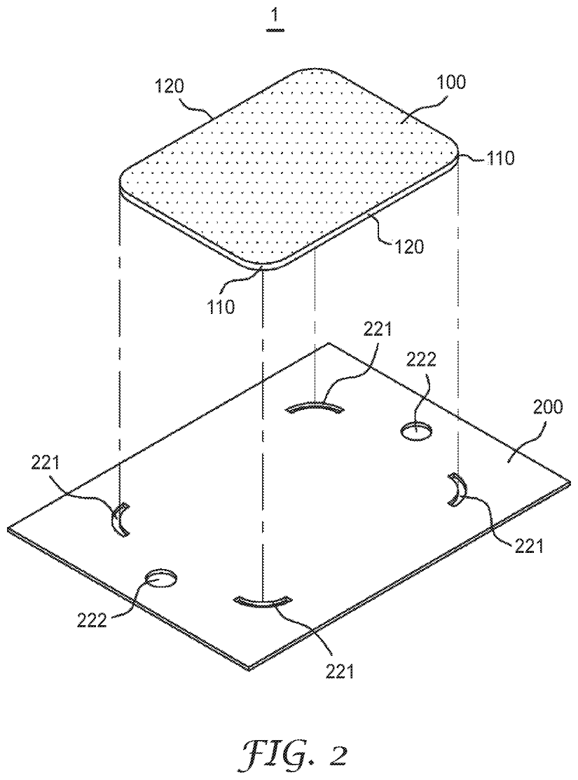

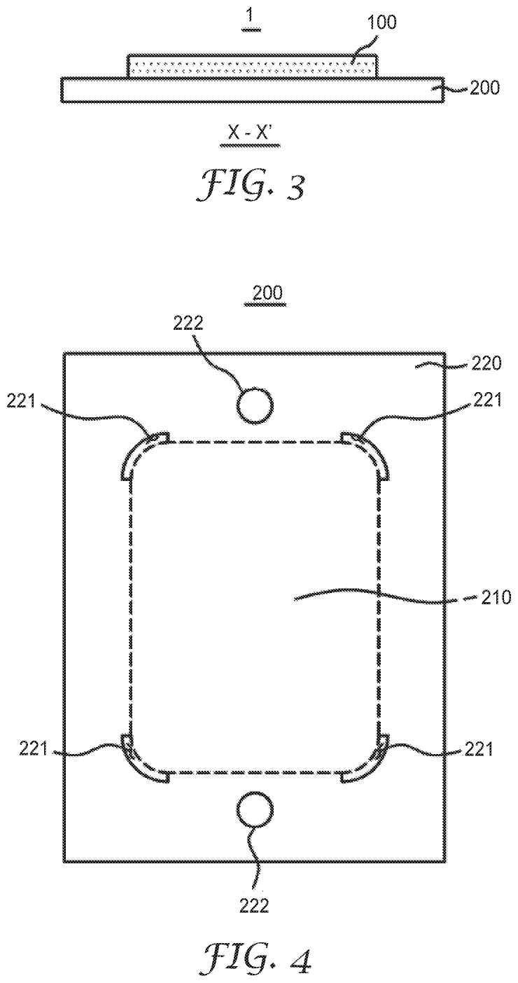

Referring to FIGS. 2 and 3, the adhesive layer 100 may bond various materials included in the display panel to one another. For example, the display panel may be fabricated by laminating cover glass, a sensor unit, a polarizing plate, an OLED layer, or the like, and the adhesive layer 100 may be interposed between the materials to bond the materials to one another. In addition, the adhesive layer 100 may be a transparent material to allow light to transmit therethrough. For example, the adhesive layer 100 may be an optically clear adhesive (OCA) film.

The adhesive layer 100 may be disposed on a first area 210 of one surface of the guide film 200, which will be described below. In addition, the adhesive layer 100 may be fabricated to have a thickness of 100 um to 200 um inclusive. The adhesive layer 100 may be fabricated to correspond to a shape of a material. For example, the adhesive layer 100 may have a shape formed with a curved portion and a straight portion as shown in FIG. 2. The adhesive layer 100 may include a corner portion 110 and a straight portion 120.

Referring back to FIG. 2, the corner portion 110 may be a portion of the circumference of the adhesive layer 100. In other words, the corner portion 110 may have a curved shape and may be a curved portion of the circumference of the adhesive layer 100. For example, four or more corner portions 110 may be provided.

The straight portion 120 may be a portion of the circumference of the adhesive layer 100. In other words, the straight portion 120 may have a straight line shape, and may be a straight portion of the circumference of the adhesive layer 100. The straight portion 120 may be connected with the corner portion 110, and may be provided as many as the number of the corner portions 110. For example, four or more straight portions 120 may be provided.

The guide film 200 may prevent the adhesive layer 100 from sticking to an article in order to maintain adhesiveness of the adhesive layer 100. In addition, the guide film 200 may guide a position of the adhesive layer 100 when the adhesive layer 100 is bonded to a material. The guide film 200 may be fabricated to have a thickness of 50 um to 100 um inclusive. In addition, the guide film 200 may include at least one of polypropylene (PP) and polyethylene terephthalate (PET). The guide film 200 may be a laminate including a plurality of layers. For example, the guide film 200 may be formed with multi-layers. The guide film 200 may include the first area 210 and a second area 220 surrounding the first area 210.

Referring to FIG. 4, the first area 210 may be an area in which the adhesive layer 100 is disposed on the guide film 200. The first area 210 may have a shape corresponding to the shape of the adhesive layer 100. For example, in the specification, the first area 210 may be a shape formed with a straight portion and a curved portion as indicated by a dashed line in FIG. 4.

The second area 220 may be an area surrounding the first area 210 of the guide film 200. When a user bonds the adhesive layer 100 to a material, a position of the adhesive layer 100 may be adjusted through the second area 220 of the guide film 200. A cut-out portion 221 may be provided within a circumference of the second area 220 to be disposed on a position adjacent to the adhesive layer 100. In addition, a guide hole 222 may be formed in the second area 220.

The cut-out portion 221 can minimize wrinkles on the adhesive layer 100, and can prevent air bubbles from being generated between the adhesive layer 100 and a material disposed on one surface of the adhesive layer 100. The cut-out portion 221 may be a portion that is cut along the corner portion 110 of the adhesive layer 100 on the guide film 200. In other words, the cut-out portion 221 may be formed on a position of the second area 220 adjacent to the corner portion 110 when the adhesive layer 100 is disposed on the first area 210. The cut-out portion 221 may be extended along at least a portion of the corner portion 110.

The guide hole 222 may provide a portion for fixing the guide film 200 not to change a position of the adhesive layer 100 when the adhesive layer 100 is bonded to a material. For example, a fixing mechanism (not shown) may be inserted into the guide hole 222 to fix the guide film 200, and the fixed guide film 200 can prevent the position of the adhesive layer 100 from being changed.

Hereinafter, operations and effects of the adhesive film 1 having the above-described configuration will be described.

The adhesive film 1 according to an embodiment of the present disclosure may be used to bond a material. The user may place the adhesive layer 100 on a material to bond the adhesive layer 100 by using the guide film 200. In addition, one surface of the adhesive layer 100 may be bonded to the material, and then, the guide film 200 bonded to the other surface of the adhesive layer 100 may be removed. When the guide film 200 is removed, another material may be bonded to the other surface of the adhesive layer 100.

When the adhesive layer 100 is attached to the material, the adhesive film 1 can minimize wrinkles generated on the adhesive layer 100, and can prevent air bubbles from being generated between the adhesive layer 100 and the material.

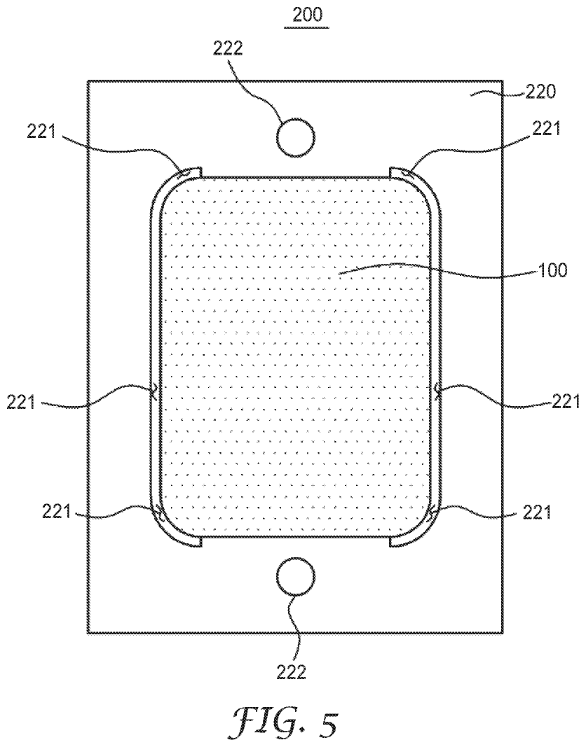

According to a second embodiment of the present disclosure, the guide film 200 may be cut along the straight portion 120 in addition to the above-described configuration. Hereinafter, the second embodiment of the present disclosure will be described with reference to FIGS. 5 to 7. In describing the second embodiment, the differences from the embodiment already described above are mainly described, and the same description and reference numerals are referred to the above.

The cut-out portion 221 may include not only a portion that is cut along the corner portion 110 of the adhesive layer 100 on the guide film 200, but also a portion that is cut along the straight portion 120. In other words, the cut-out portion 221 may be formed on a position of the second area 220 adjacent to the corner portion 110 and the straight portion 120 when the adhesive layer 100 is disposed on the first area 210. The cut-out portion 221 may be extended along at least a portion of the straight portion 120.

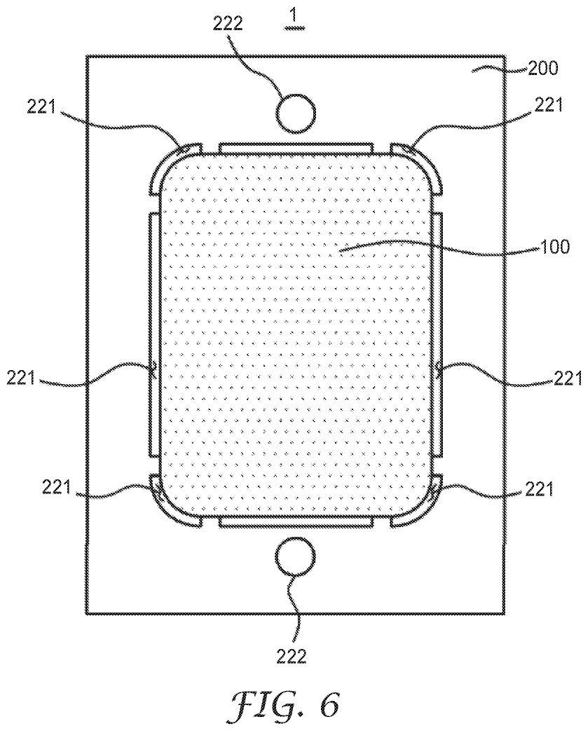

Although it is illustrated in the specification that the cut-out portion 221 is extended vertically along the straight portion 120 in FIG. 5, this is merely an example. As shown in FIG. 6, the cut-out portion 221 may be extended horizontally along the straight portion 120. In addition, the cut-out portion 221 may be extended along at least a portion of the corner portion 110 and the straight portion 120, such that the cut-out portion 221 is discontinuously formed.

Hereinafter, operations and effects of the adhesive film 1 according to the second embodiment of the present disclosure will be described.

The adhesive film 1 according to the second embodiment of the present disclosure may be used to bond a material. The user may remove a protection film 300 to bond the adhesive layer 100 to the material. When one surface of the adhesive layer 100 is exposed to the outside after the protection film 300 is removed, the user may bond the one surface of the adhesive layer 100 to the material. The user may remove the guide film 200 and may bond a material to the other surface of the adhesive layer 100.

When the adhesive layer 100 is attached to the material, the adhesive film 1 can minimize wrinkles generated on the adhesive layer 100, and can prevent air bubbles from being generated between the adhesive layer 100 and the material. In addition, when the adhesive film 1 is transported, transferred, or sold, there is an effect that the adhesive film 1 is stuck to other materials to prevent adhesiveness of the adhesive layer 100 from being reduced.

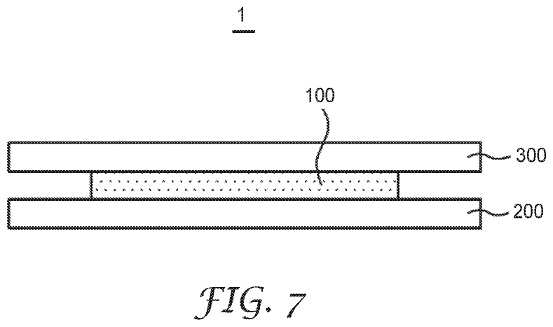

Referring to FIG. 7, the adhesive film 1 in the above-described embodiments may further include the protection film 300 selectively. The protection film 300 may be bonded to the adhesive layer 100 to protect a surface of the adhesive layer 100. In addition, the protection film 300 may be removed from the adhesive layer 100 before the adhesive layer 100 is attached to a material.

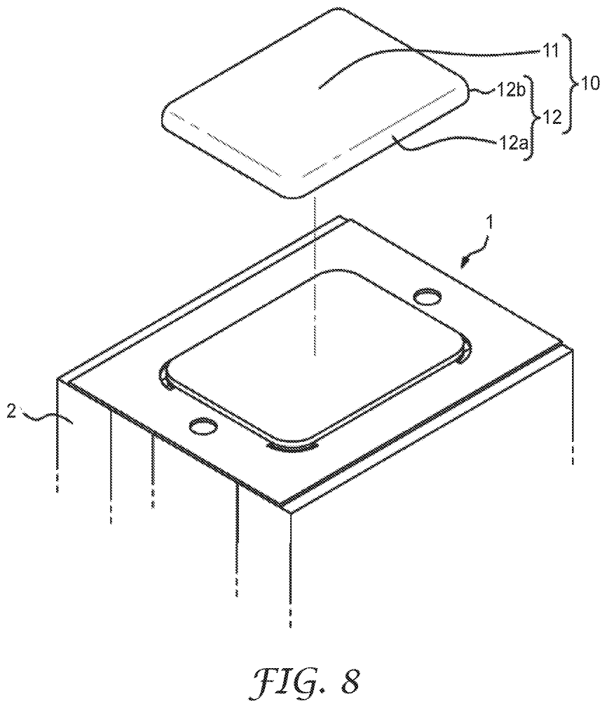

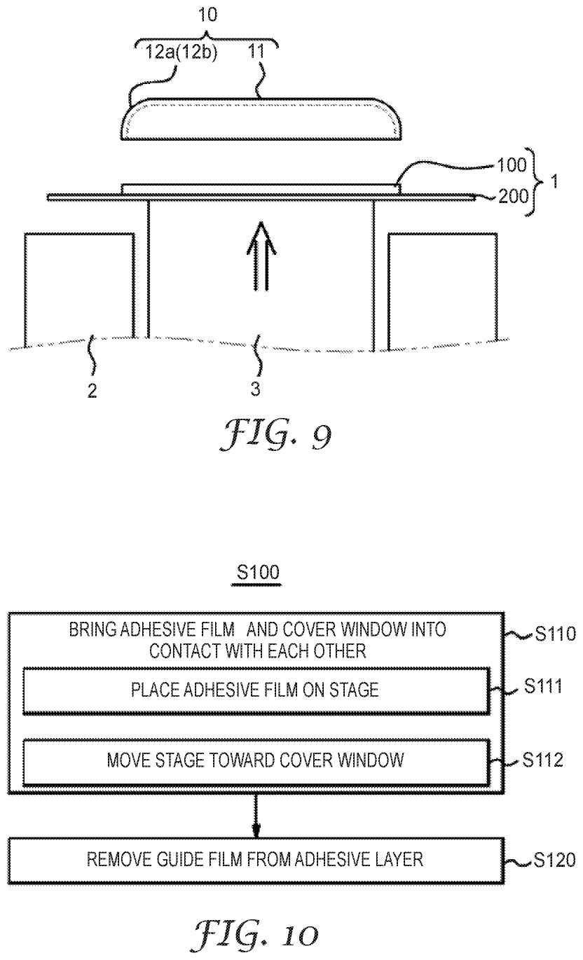

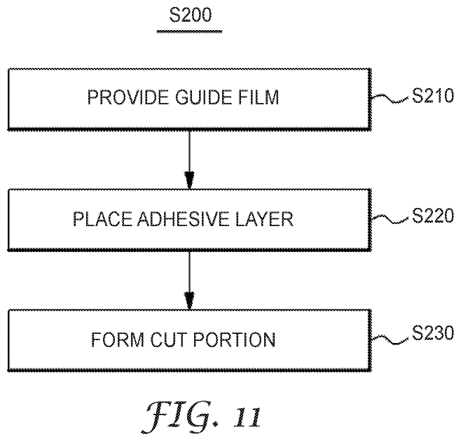

Hereinafter, an adhesive film laminating method S100 which laminates the adhesive film 1 according to an embodiment of the present disclosure on a material having an edge bended will be described with reference to FIGS. 8 to 10.

A user may laminate the adhesive film 1 on an edge bended material through the adhesive film laminating method S100. Herein, the edge bended material may be, for example, a cover window 10 used for a smartphone or the like, as shown in FIG. 8. The cover window 10 may be a double edge bending cover window, or may be a quad edge bending cover window. Although it is illustrated in the specification that the cover window 10 is the quad edge bending cover window, this is merely an example and the present disclosure is not limited thereto.

The cover window 10 may include a planar portion 11 and a bending edge portion 12 positioned around the planar portion 11.

The planar portion 11 may be a portion that is flat in the cover window 10.

In addition, the bending edge portion 12 may be a portion that is bent on an edge of the cover window 10. The bending edge portion 12 may be a portion that is positioned around the planar portion 11, and may include a portion that surrounds the periphery of the planar portion 11. In addition, a plurality of bending edge portions 12 may be provided. For example, four bending edge portions 12 may be provided. The bending edge portion 12 may include a straight extension portion 12a and a curved portion 12b.

The straight extension portion 12a may be a portion that is formed in a straight line in the bending edge portion 12 when viewed in a normal line direction of the planar portion 11. In addition, the curved portion 12b may be a portion that is curved in the bending edge portion 12 when viewed in the normal line direction of the planar portion 11. Two curved portions 12b may be provided, and the two curved portions 12b may be positioned on both sides of the straight extension portion 12a when viewed in the normal line direction of the planar portion 11.

Hereinafter, the adhesive film laminating method S100 for bonding the adhesive film 1 on the cover window 10 will be described. The adhesive film laminating method S100 may include a step S110 of bringing the adhesive film 1 and the cover window 10 into contact with each other, and a step S120 of removing the guide film 200 from the adhesive film 100.

The step S110 of bringing the adhesive film 1 and the cover window 10 into contact with each other may bring the adhesive film 1 and the cover window 10 into contact with each other to bond the adhesive layer 100 to the cover window 10. For example, the adhesive layer 100 may be bonded to the cover window to have the corner portion 110 disposed on a position corresponding to any one of the two curved portions 12b. More specifically, the adhesive layer 100 may be bonded such that each of the four corner portions 110 is disposed on a position corresponding to one side of any one of the four bending edge portions 12 and one side of another of the four bending edge portions 12 adjacent to the one bending edge portion. In addition, the adhesive layer 100 may be bonded to the cover window to have the straight portion 120 disposed on a position corresponding to the straight extension portion 12a.

The step S110 of bringing the adhesive film 1 and the cover window 10 into contact with each other may include a step S111 of placing the adhesive film 1 on a stage 3, and a step S112 of moving the stage 3 toward the cover window 10.

At the step S111 of placing the adhesive film 1 on the stage 3, the adhesive film 1 may be placed on the stage 3 such that the adhesive film 1 is supported on a jig 2 or the stage 3 disposed between the jigs 2.

At the step S112 of moving the stage 3 toward the cover window 10, the stage 3 supporting the adhesive film 1 may be moved toward the cover window 10 to bring the adhesive film 1 into contact with the cover window 10.

At the step S120 of removing the guide film 200 from the adhesive layer 100, the guide film 200 may be removed from the adhesive layer 100. When the guide film 200 is removed, the other surface of the adhesive layer 100 that is not bonded to the cover window 10 may be bonded to another material.

Hereinafter, an adhesive film fabrication method S200 for fabricating the adhesive film 1 according to embodiments of the present disclosure will be described with reference to FIG. 11.

The adhesive film fabrication method S200 may provide a method for fabricating the adhesive film 1 for bonding a material. The adhesive film fabrication method S200 may include a step S210 of providing a guide film, a step S220 of placing an adhesive layer, and a step S230 of forming a cut-out portion.

At the step S210 of providing the guide film, the guide film 200 including at least one of polypropylene (PP) and polyethylene terephthalate (PET) may be provided.

At the step S220 of placing the adhesive layer, the adhesive layer 100 may be placed on the guide film 200.

At the step S230 of forming the cut-out portion, the cut-out portion 221 disposed on a position adjacent to the corner portion 110 of the adhesive layer 100 may be formed on the guide film 200. At the step S230 of forming the cut-out portion, the cut-out portion 221 may be extended along at least a portion of the corner portion 110 and the straight portion 120.

Although embodiments of the present disclosure have been described by referring to specific embodiments, these are merely certain examples, and the present disclosure is not limited thereto, and should be interpreted as having the broadest scope according to the basic idea disclosed herein. Those skilled in the art will be able to combine and/or substitute the disclosed embodiments to effect a pattern of a shape that has not been stated herein, but this also does not depart from the scope of the present disclosure. Further, it will be apparent to those skilled in the art that various changes and modifications may be readily made without departing from the idea and scope of the invention as defined by the appended claims.

### DESCRIPTION OF REFERENCE NUMERALS

| | |
|---|---|
| 1: adhesive film | 2: jig |
| 3: stage | 10: cover window |
| 11: planar portion | 12: bending edge portion |
| 12a: straight extension portion | 12b: curved portion |
| 100: adhesive layer | 110: corner portion |
| 120: straight portion | 200: guide film |
| 210: first area | 220: second area |
| 221: cut-out portion | 222: guide hole |
| 300: protection film | |

1. An adhesive film comprising:
a guide film comprising a first area and a second area surrounding the first area; and
an adhesive layer disposed on the first area,
wherein the first area has a shape corresponding to a shape of the adhesive layer, and
wherein a cut-out portion is provided within a circumference of the second area and positioned adjacent to the adhesive layer.

2. The adhesive film of claim 1,
wherein the adhesive layer comprises a corner portion, and
wherein the cut-out portion is disposed on a position adjacent to the corner portion.

3. The adhesive film of claim 2,
wherein the corner portion has a curved shape.

4. The adhesive film of claim 2,
wherein the adhesive layer comprises a straight portion, and
wherein the cut-out portion is extended along the corner portion and at least a portion of the straight portion.

5. The adhesive film of claim 1,
wherein the guide film has a thickness of 50 um to 100 um.

6. The adhesive film of claim 5,
wherein the adhesive layer has a thickness of 100 um to 200 um.

7. The adhesive film of claim 1,
wherein the guide film comprises at least one of polypropylene (PP) and polyethylene terephthalate (PET).

8. The adhesive film of claim 2,
wherein four or more corner portions are provided.

9. An adhesive film laminating method for laminating an adhesive film on a cover window, the adhesive film having a guide film and an adhesive layer disposed on one side of the guide film, the cover window having a planar portion and a plurality of bending edge portions positioned around the planar portion, the method comprising:
bringing the adhesive film and the cover window into contact with each other to bond the adhesive layer to the cover window; and
removing the guide film from the adhesive layer.

10. The method of claim 9,
wherein each of the bending edge portions has a straight extension portion and two curved portions, and the two curved portions are respectively positioned on both sides of the straight extension portion when viewed in a direction perpendicular to the planar portion,
wherein the adhesive layer comprises a corner portion, and
wherein the adhesive layer is bonded to the cover window to have the corner portion disposed on a position corresponding to any one of the two curved portions.

11. The method of claim 10,
wherein the adhesive layer comprises a straight portion, and
wherein the adhesive layer is bonded to the cover window to have the straight portion is positioned corresponding to the straight extension portion.

12. The method of claim 9,
wherein the plurality of bending edge portions are four bending edge portions,
wherein the adhesive layer comprises four corner portions, and
wherein the adhesive layer is bonded to the cover window such that each of the four corner portions is disposed on a position corresponding to one side of any one of the four bending edge portions and one side of another of the four bending edge portion adjacent to the one bending edge portion.

13. The method of claim 9,
wherein the step of bringing the adhesive film and the cover window into contact with each other comprises the steps of:
placing the adhesive film on a stage; and
moving the stage supporting the adhesive film toward the cover window to bring the adhesive film and the cover window into contact with each other.

14. The method of claim 9,
wherein the adhesive layer comprises four or more corner portions.

15. An adhesive film fabrication method comprising:
providing a guide film;
placing an adhesive layer on the guide film; and
forming a cut-out portion to be disposed on a position adjacent to a corner portion of the adhesive layer.
